(19) United States
(12) Patent Application Publication
(10) Pub. No.: US 2025/0279621 A1
(43) Pub. Date: Sep. 4, 2025

(54) ELECTRICAL ASSEMBLY

(71) Applicant: Lear Corporation, Southfield, MI (US)

(72) Inventor: Ajmal Imran Ansari, Canton, MI (US)

(73) Assignee: Lear Corporation, Southfield, MI (US)

(21) Appl. No.: 19/065,169

(22) Filed: Feb. 27, 2025

Related U.S. Application Data
(60) Provisional application No. 63/560,099, filed on Mar. 1, 2024.

(51) Int. Cl. H01R 25/16; B60R 16/033; H01R 13/533

(52) U.S. Cl. CPC H01R 25/162; B60R 16/033; H01R 13/533; H01R 2201/26

(57) ABSTRACT

An electrical assembly, comprising an electrical contactor including a first terminal; a bus bar connected to the first terminal; and a heat spreader molded onto the electrical contactor and the bus bar. The heat spreader can comprise a thermoset material that is electrically insulating and thermally conductive. The bus bar can be welded with the first terminal.

### CROSS-REFERENCE TO RELATED APPLICATIONS

This application claims the benefit of and priority to U.S. Provisional Application 63/560,099 filed Mar. 1, 2024, the disclosure of which is hereby incorporated by reference in its entirety as though fully set forth herein.

### TECHNICAL FIELD

The present disclosure generally relates to electrical assemblies, including electrical contactor assemblies that can, for example, be utilized in connection with vehicles including high voltage systems.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view generally illustrating an embodiment of an electrical assembly according to teachings of the present disclosure.

FIG. 2 is a perspective view generally illustrating an embodiment of a contactor according to teachings of the present disclosure.

FIG. 3 is a perspective view generally illustrating an embodiment of an electrical assembly, with a heat spreader hidden, according to teachings of the present disclosure.

FIG. 4 is a cross-sectional view generally illustrating an embodiment of an electrical assembly, with a heat spreader hidden, according to teachings of the present disclosure.

FIG. 5 is a perspective view generally illustrating an embodiment of an electrical assembly according to teachings of the present disclosure.

FIG. 6 is a cross-sectional view generally illustrating an embodiment of an electrical assembly according to teachings of the present disclosure.

FIG. 7 is an enlarged version of a part of FIG. 6 along with embodiments of a cold plate and a charger according to teachings of the present disclosure.

FIG. 8 is a cross-sectional view generally illustrating an embodiment of portions of an electrical assembly and a mold according to teachings of the present disclosure.

FIG. 9 is a flow chart generally illustrating an embodiment of a method of assembling an electrical assembly according to teachings of the present disclosure.

FIG. 10 is a schematic view generally illustrating an embodiment of a vehicle according to teachings of the present disclosure.

FIG. 11 is a flow chart generally illustrating an embodiment of a method of assembling a vehicle according to teachings of the present disclosure.

FIG. 12 is a flow chart generally illustrating an embodiment of a method of operating a vehicle according to teachings of the present disclosure.

FIG. 13 is a perspective view generally illustrating an embodiment of a contactor according to teachings of the present disclosure.

FIG. 14 is a perspective view generally illustrating an embodiment of an electrical assembly according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

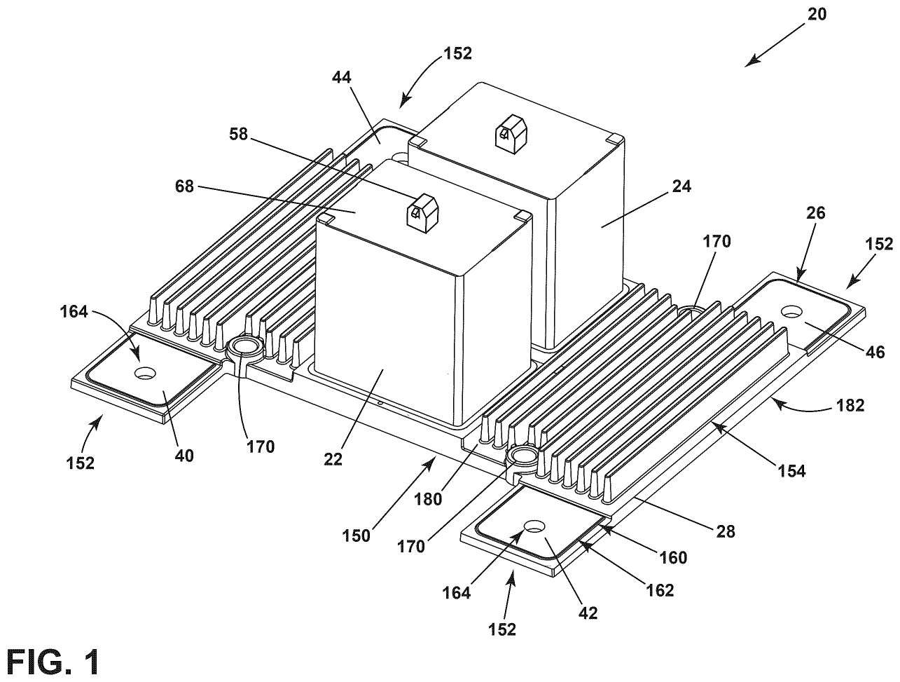

Referring to FIG. 1, an electrical assembly 20 includes a first contactor 22, a second contactor 24, a set of bus bars 26, and/or a heat spreader 28. The set of bus bars 26 includes a first bus bar 40, a second bus bar 42, a third bus bar 44, and/or a fourth bus bar 46. The first and second bus bars 40, 42 are electrically connected to the first contactor 22, and the first contactor 22 selectively electrically connects the first bus bar 40 with the second bus bar 42. The third and fourth bus bars 44, 46 are electrically connected to the second contactor 24, and the second contactor 24 selectively electrically connects the third bus bar 44 with the fourth bus bar 46. Operation of the contactors 22, 24 generates heat, such as via electrical current flowing through the contactors 22, 24 (e.g., a low voltage coil, a movable contact, terminals, etc.) and the set of bus bars 26. The heat spreader 28 facilitates dissipating at least some of the generated heat.

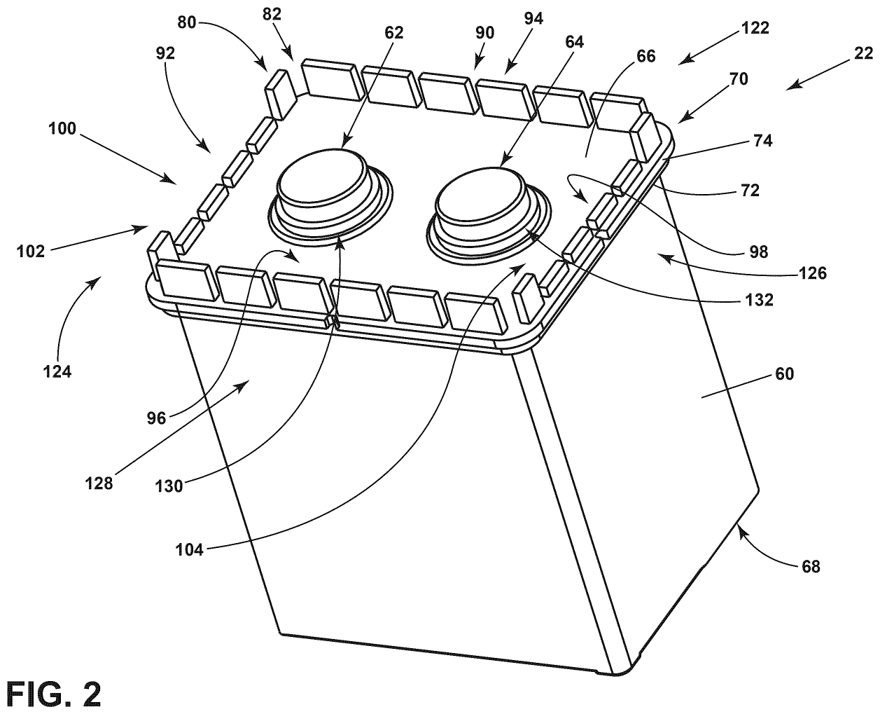

Referring to FIG. 2, the first contactor 22 includes a housing 60, a first terminal 62, and a second terminal 64. The housing 60 is generally rectangular with one or more rounded edges, but can include other configurations. The first terminal 62 and the second terminal 64 extend from a first side 66 of the housing 60. An electrical connector 58 (FIG. 1) extends from a second side 68 of the housing 60 that is opposite the first side 66. The electrical connector 58 (FIG. 1) is a low voltage electrical connector 58 and is utilized to control operation of the first contactor 22 to selectively electrically connect the first terminal 62 with the second terminal 64, which selectively electrically connects the first bus bar 40 and the second bus bar 42 (FIG. 1). The housing 60 includes a flange 70 that extends outward generally parallel to the first side 66. Optionally, the flange 70 defines at portion of the first side 66. The flange 70 includes a first section 72 and a second section 74 that extends beyond the first section 72 such that the flange 70 includes a stepped configuration. The second section 74 may define the portion of the first side 66. The first section 72 is closer to the second side 68 than the second section 74.

The housing 60 includes a plurality of tabs 80 that extend from the first side 66 and are separated by a plurality of gaps 82. The tabs 80 are spaced about a perimeter of the first side 66. The plurality of tabs 80 include a plurality of first tabs 90 and a plurality of second tabs 92. The first tabs 90 are longer and extend farther from the first side 66 than the second tabs 92. The first tabs 90 include a first group of first tabs 94 and a second group of first tabs 96. The second tabs 92 include a first group of second tabs 98 and a second group of second tabs 100. The first group of first tabs 94 are spaced along a first long side 122 of the housing 60, part of a first short side 124 of the housing 60, and part of a second short side 126 of the housing 60. The second group of first tabs 96 are spaced along a second long side 128 of the housing 60. The first and second groups of second tabs 98, 100 are spaced along the first and second short sides 124, 126, respectively. The first and second groups of second tabs 98, 100 are disposed between the first and second groups of first tabs 94, 96 to define a first recess 102 and a second recess 104. The heights of the recesses 102, 104 are equal to the difference in height between the first tabs 90 and the second tabs 92. Some or all of the plurality of tabs 80 can extend from the flange 70. The second contactor 24 can include the same or similar configuration as the first contactor 22.

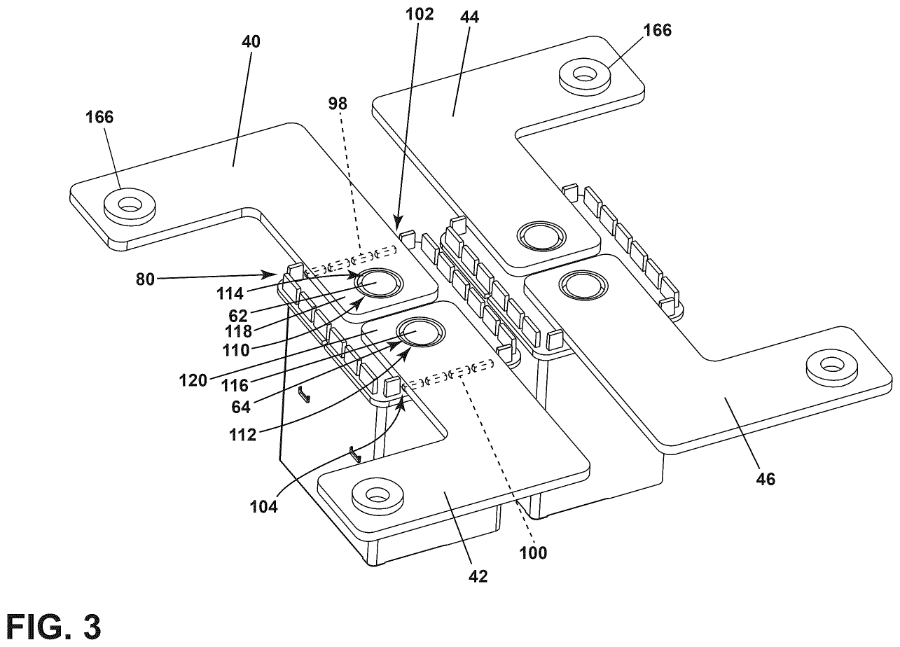

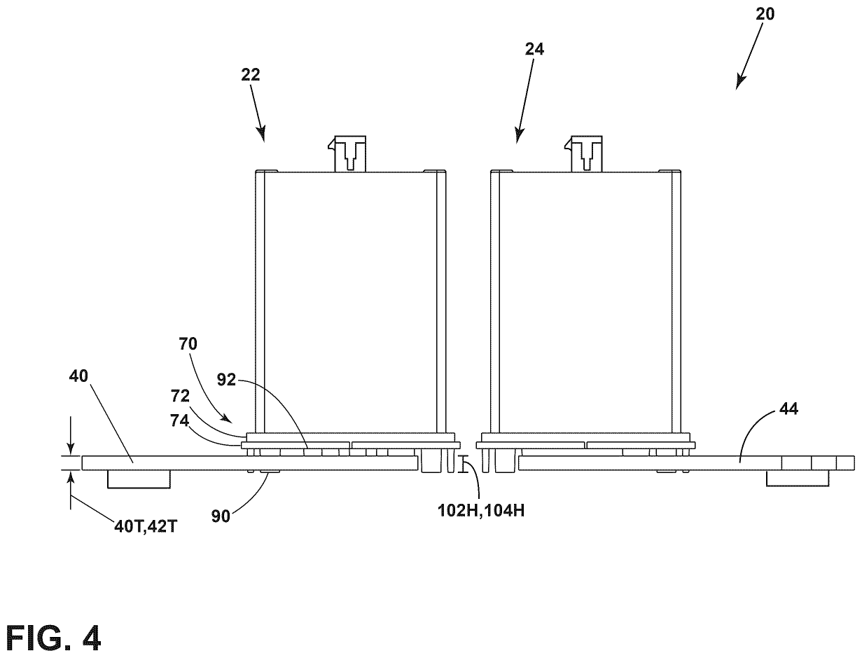

Referring to FIG. 3, which illustrates the contactors 22, 24 and the set of bus bars 26 with the heat spreader 28 hidden, the first bus bar 40 is disposed partially in the recess 102 and the second bus bar 42 is disposed partially in the recess 104. For example, the first bus bar 40 extends through the recess 102 to connect with the first terminal 62 and is in contact with outer edges of the first group of second tabs 98. Additionally or alternatively, the second bus bar 42 extends through the recess 104 to connect with the second terminal 64 and is in contact with outer edges of the second group of second tabs 100. Referring to FIG. 4, the heights 102H, 104H of the recesses 102, 104 can be at least as large or larger than the thicknesses 40T, 42T of the bus bars 40, 42. For example, the first tabs 90 extend beyond at least the portions of the bus bars 40, 42 disposed on the second tabs 92.

Referring again to FIG. 3, the first bus bar 40 is fixed to the first terminal 62, and the second bus bar 42 is fixed to the second terminal 64. For example, the first bus bar 40 includes an aperture 110 into which the first terminal 62 extends, and the second bus bar 42 includes an aperture 112 into which the second terminal 64 extends. The bus bars 40, 42 are welded (e.g., laser welded) to the terminals 62, 64. Optionally, the outer surfaces 114, 116 of the terminals 62, 64 are coplanar with the outer surfaces 118, 120 of the bus bars 40, 42. Additionally or alternatively, the set of bus bars 26 are connected (e.g., fixed) to the terminals 62, 64 other than via welding, such as via fasteners. In some configurations, such as illustrated in FIG. 2, the terminals 62, 64 include shoulders 130, 132. The shoulders 130, 132 are portions of the terminals 62, 64 with increased outer dimensions (e.g., diameters for circular terminals) relative to at least some other portions of the terminals 62, 64. Some or all of the outer dimensions of the shoulders 130, 132 are larger than the inner dimensions of the apertures 110, 112 (FIG. 3) such that the bus bars 40, 42 (FIG. 3) are disposed on the shoulders 130, 132, and the shoulders 130, 132 limit the insertion depth of the terminals 62, 64. Optionally, the shoulders 130, 132 are aligned with (e.g., extend beyond the first side 66 the same distance as) the second tabs 92 such that the bus bars 40, 42 contact the shoulders 130, 132 and the second tabs 92 and are parallel to the first side 66.

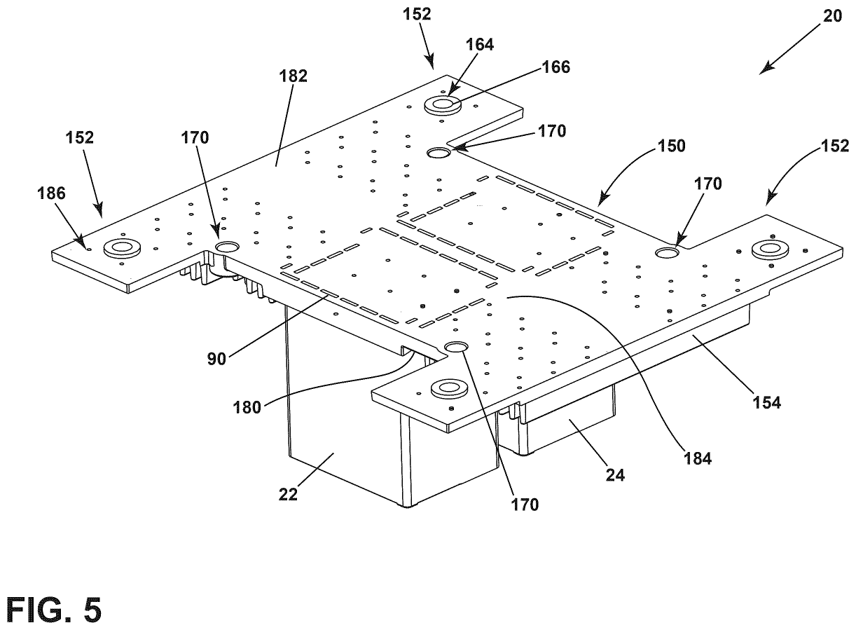

Referring to FIGS. 1 and 5, the heat spreader 28 is formed onto the contactors 22, 24 and the set of bus bars 26, such as after the set of bus bars 26 are fixed to the contactors 22, 24. The heat spreader 28 includes a base section 150, a plurality of extensions 152 that extend from the base section 150, and a plurality of fins 154 that extend from the base section 150. The base section 150 extends over portions of the contactors 22, 24 and portions of the set of bus bars 26, such as to facilitate heat dissipation from the contactors 22, 24 and/or the set of bus bars 26. The extensions 152 cover some surfaces of the ends 162 of the set of bus bars 26, and define open portions 160 that expose at least one surface of the ends 162 of the set of bus bars 26, such as for electrical connection with other components (e.g., cables, wires, bus bars, fuses, terminals, among others). The ends 162 can, for example, include apertures 164 for engaging fasteners for electrically connecting the set of bus bars 26 with other components. Additionally or alternatively, the ends 162 can include clinch nuts 166 extending into and/or through the apertures 164 (FIG. 5). The clinch nuts 166 can be connected to the ends 162 before or after the set of bus bars 26 are welded with the contactors 22, 24.

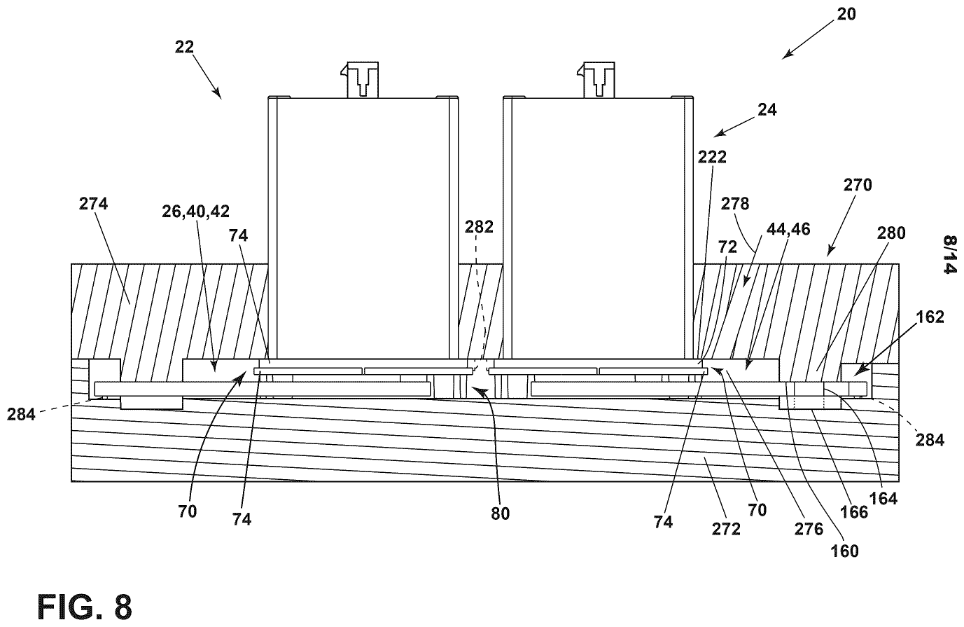

The base section 150 includes a plurality of mounting apertures 170 that extend through the base section 150 for mechanically mounting the electrical assembly 20 to another component. The base section 150 includes a first surface 180 from which the plurality fins 154 extend, and includes a second surface 182 opposite the first surface 180. The second surface 182 is planar and can be formed flush with the outer edges of the first tabs 90 such that the heat spreader 28 and/or the first tabs 90 provide at least a portion of a planar mounting surface 184 of the electrical assembly 20 (FIG. 5). The heat spreader 28 can include one or more locating holes 186 that may be formed by pins 284 of a mold 270 (FIG. 8), such as to support and locate the set of bus bars 26 during formation of the heat spreader 28.

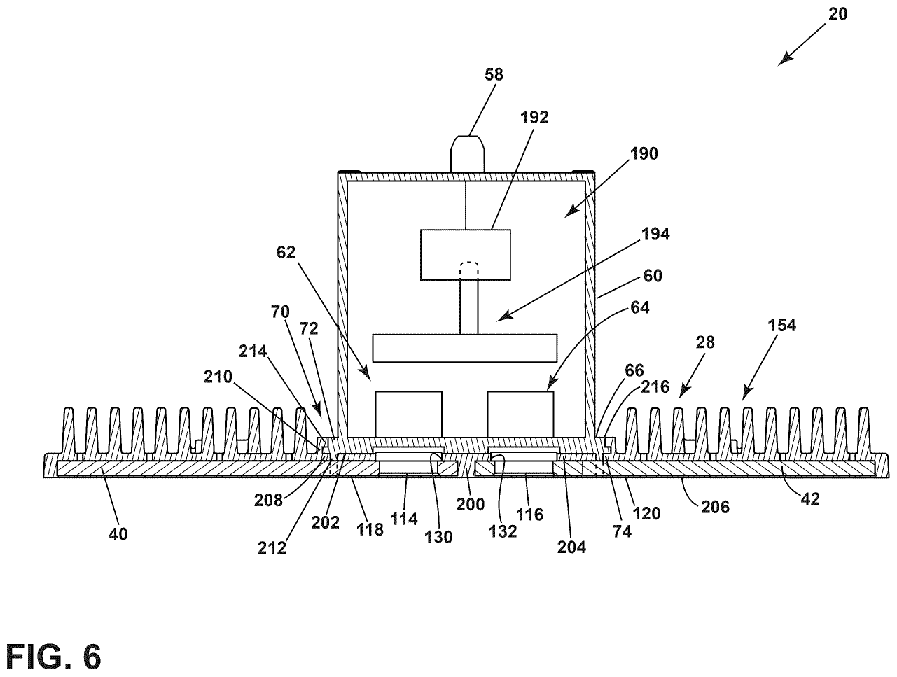

Referring to FIG. 6, the first contactor 22 includes the first and second terminals 62, 64 and an internal assembly 190 that selectively electrically connects the first and second terminals 62, 64. The internal assembly 190 can include an electromagnet 192 that controls movement of an armature 194 into and out of contact with the terminals 62, 64. The electromagnet 192 is connected to the electrical connector 58.

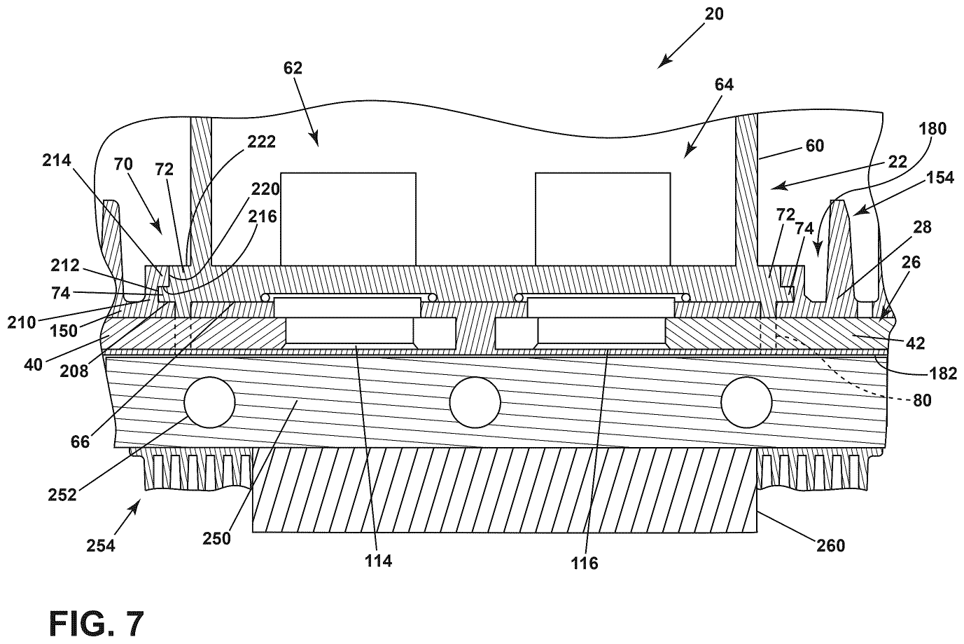

Referring to FIGS. 6 and 7, the heat spreader 28 covers various portions of the electrical assembly 20 and forms a generally plate-like structure. The base section 150 covers the outer surfaces 114-120 of the terminals 62, 64 and the bus bars 40, 42. The base section 150 includes a first portion 200 disposed between and in contact with the first bus bar 40 and the second bus bar 42. The base section 150 includes a second portion 202 disposed between and in contact with the first bus bar 40 and the first side 66. The second portion 202 is also in contact with the first terminal 62, such as with a surface of the first terminal 62 that extends from the shoulder 130 to or toward the first side 66. For example, the housing 60, the first bus bar 40, and the heat spreader 28 can cooperate to cover some, most, or all of the first terminal 62. The base section 150 includes a third portion 204 disposed between and in contact with the second bus bar 42 and the first side 66. The third portion 204 is also in contact with the second terminal 62, such as with a surface of the first terminal 62 that extends from the shoulder 132 to or toward the first side 66. For example, the housing 60, the second bus bar 42, and the heat spreader 28 can cooperate to cover some, most, or all of the second terminal 64. Additionally or alternatively, the heat spreader 28 covers some, most, or all of the first side 66 of the housing 60. The base section 150 includes a fourth portion 206 that covers the outer the outer surfaces 118, 120 of the set of bus bars 26, apart from the open portions 160, and the outer surfaces 114, 116 of the terminals 62, 64.

Referring to FIG. 7, the base section 150 includes a fifth portion 208 disposed on the second section 74 of the flange 70 at the first side 66 of the housing 60. The base section 150 includes a sixth portion 210 that covers a side 212 of the second section 74 that is angled (e.g., at right angle) relative to the first side 66 of the housing 60. The base section 150 includes a seventh portion 214 that covers at least a portion of an inner surface 216 of the second section 74 of the flange 70. The inner surface 216 is offset from the first side 66 of the housing toward the second side 68 (FIG. 6) of the housing 60. The seventh portion 214 helps secure the heat spreader 28 with the first contactor 22. For example, the second section 74 is disposed at least partially between the fifth and seventh portions 208, 214. The first section 72 of the flange 70 includes a side 220 and an inner surface 222 offset from the inner surface 216 of the second section 74 toward the second side 68 (FIG. 6) of the housing 60. The heat spreader 28 (e.g., the base section 150) may cover some, none, or all of the side 220, and may cover some or none of the inner surface 222. For example, the seventh portion 214 can cover all of the side 220 and none of inner surface 222 such that the seventh portion 214 is flush with the inner surface 222. Other portions of the base section 150 can be disposed in other locations, such as on and around the plurality of tabs 80 and in the plurality of gaps 82. The plurality of tabs 80 provide additional surface area for the base section 150 to be molded onto and can help maintain the relative positions of the contactors 22, 24, and the heat spreader 28. The flange 70 can be devoid of fasteners and/or apertures for fasteners. The housing 60 can be mounted to the heat spreader 28 without fasteners.

The electrical assembly 20 can include and/or be connected to a cold plate 250, which can dissipate heat from the heat spreader 28, such as to further dissipate heat from the contactors 22, 24 and/or the set of bus bars 26. The cold plate 250 can be liquid cooled and/or air cooled. For example, the cold plate 250 can include one or more fluid passages 252 for cooling fluid, and/or can include one or more fins 254. Optionally, another component, such as a battery charger 260 is connected to the cold plate 250, such as opposite the electrical assembly 20. The cold plate 250 may then operate to dissipate heat from the electrical assembly 20 and the battery charger 260. When connecting the heat spreader 28 to the cold plate 250, a film or layer of material (e.g., thermally conductive paste) can be applied between the heat spreader 28 and the cold plate 250 to fill gaps therebetween.

In some examples, the electrical assembly 20 may not include or be directly connected to a second heat exchanger, such as the cold plate 250. With such examples, the second surface 182 of the heat spreader 28 can include the fins 154, such as in addition to or instead of the first surface 180. The configuration (e.g., number, size, geometry, arrangement) of the fins 154 can vary. In examples with the fins 154 at both of the first surface 180 and the second surface 182, the fins 154 may provide enough cooling to sufficiently cool the contactors 22, 24.

The heat spreader 28 comprises a thermosetting polymer, also referred to as a thermoset, that is electrically insulating and thermally conductive. The thermoset material has a coefficient of thermal expansion that is more similar to that of the set of bus bars 26, which may comprise copper, than other polymers. For example, the coefficient of thermal expansion of the thermoset can be within 10% of the coefficient of thermal expansion of the material of the set of bus bars 26. Optionally, the heat spreader 28 comprises a thermoplastic, a ceramic, or both, instead of or in addition to the thermoset material.

Forming the heat spreader 28 can include molding the thermoset onto the contactors 22, 24 and the set of bus bars 26, such as via resin transfer molding (RTM) or compression molding, which can be conducted at lower pressures than injection molding. Referring to FIG. 8, the molding process can include placing a first subassembly, including the first contactor 22 and the first bus bar, and a second subassembly, including the second contactor 24 and the second bus bar 42, at least partially in a mold 270 comprising a first mold portion 272 and a second mold portion 274. The first mold portion 272 and the second mold portion 274 are closed together to form a mold cavity 276. A thermoset material 278 is provided to the mold cavity 276 and flows around the contactors 22, 24 and the set of bus bars 26 in the mold cavity 276. The thermoset material 278 can flow through one or more of the gaps 82. Optionally, the mold 270 includes one more formations 280 (e.g., protrusions, recesses, or both), such as to form the fins 154 (FIG. 1), the open portions 160, and/or the mounting apertures 170 (FIG. 1). For example, the one or more formations 280 may form sealing edges with the ends 162 to prevent the thermoset material 278 from covering the open portions 160 and/or from flowing into the apertures 164. The one or more formations 280 can include locating pins 282, 284 for locating one or more portions of the electrical assembly 20 during formation of the heat spreader 28. For example, the locating pins 282 can be utilized to locate the contactors 22, 24, and the locating pins 284 (e.g., spring-loaded pins) can be utilized to support and locate the set of bus bars 26. Molding the heat spreader 28 can include the thermoset material 278 flowing into and/or around the formations 280 to form the fins 154 (FIG. 1), the open portions 160, and/or the mounting apertures 170 (FIG. 1). For example, the molding can include one or more formations 280 contacting the set of bus bars 26 to leave the open portions 160 uncovered, such as for electrical connection with an external component. The thermoset material 278 is allowed to cure on the contactors 22, 24 and the set of bus bars 26, which forms the heat spreader 28. After curing, the assembly, including the contactors 22, 24, the set of bus bars 26, and the heat spreader 28, is removed from the mold 270.

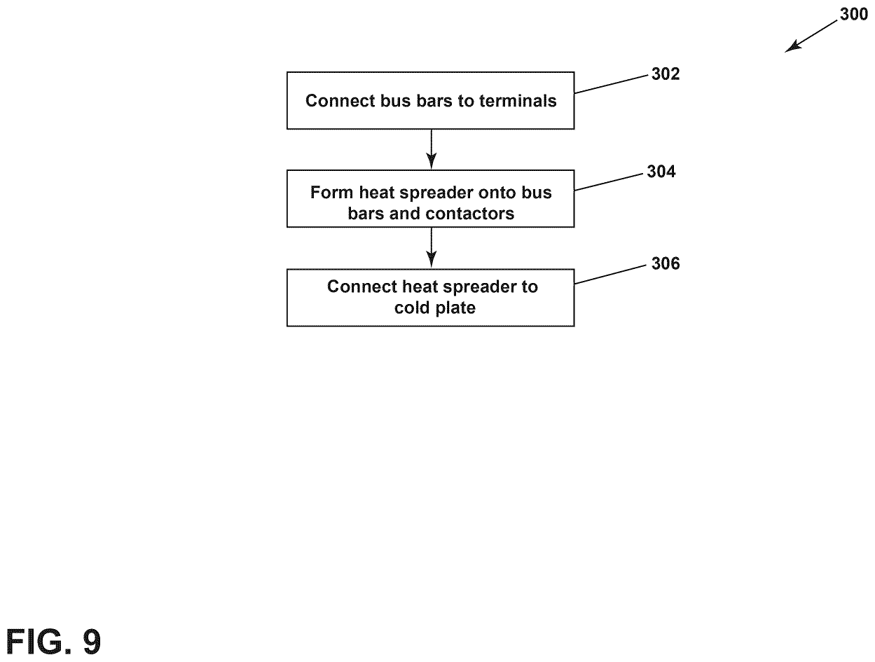

Referring to FIG. 9, a method 300 of assembling the electrical assembly 20 includes connecting (e.g., welding) the set of bus bars 26 to the contactors 22, 24 (block 302), such as to form the first and second subassemblies. Clinch nuts 166 can be connected to the set of bus bars 26 before or after block 302. The method 300 includes forming the heat spreader 28 onto the first and second subassemblies (block 304), which can include molding the heat spreader 28 on the contactors 22, 24 and the set of bus bars 26. Optionally, forming the heat spreader 28 includes molding the heat spreader 28 on and around one or more clinch nuts 166 such that at least an outer axial surface of the one or more clinch nuts 166 is not covered by the heat spreader 28. Optionally, the method 300 includes connecting the heat spreader 28 to a cold plate 250 (block 306). In other configurations, the heat spreader 28 can be connected to a component that is not a cold plate and/or that does not include cooling features (e.g., a cover of a traction battery). With some examples, block 306 can be conducted in a different location than blocks 302, 304. For example, the electrical assembly 20, without the cold plate 250, may be assembled at a first location (e.g., an electronics assembly plant) and transported to a second location (e.g., a vehicle assembly plant) for assembly with a vehicle.

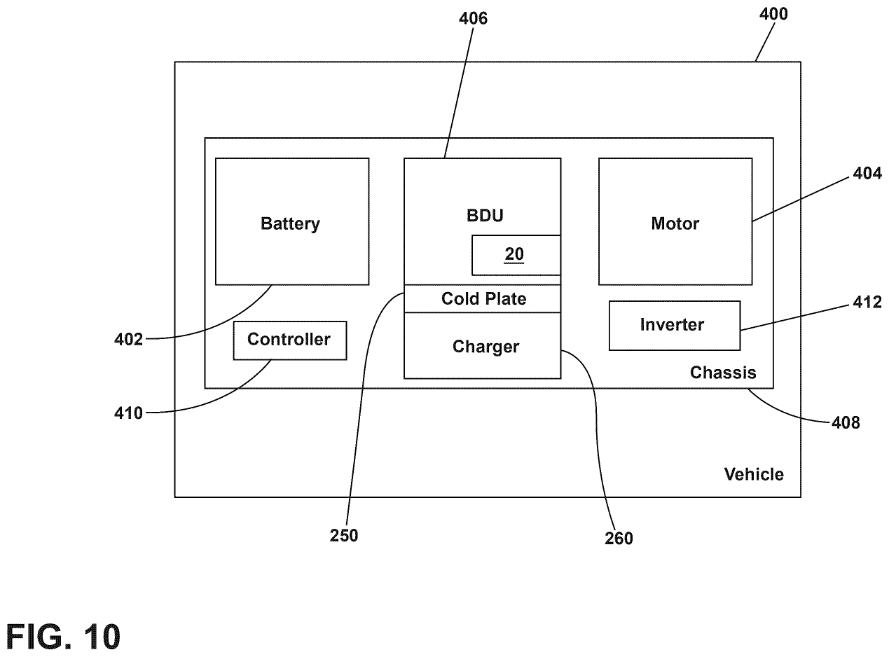

Referring to FIG. 10, a schematic illustration of a vehicle 400 is provided. The vehicle 400 includes a battery 402 (e.g., a traction battery), an electric motor 404, a battery disconnect unit (BDU) 406, a chassis 408, and/or the charger 260. The BDU 406 includes the electrical assembly 20 and selectively electrically connects the battery 402 with the electric motor 404, at least indirectly. For example, one or both of the contactors 22, 24 selectively electrically connects the battery 402 with the electric motor 404, such as via an inverter 412. The inverter 412 can, for example, be attached to a housing of the electric motor 404 and be electrically connected between the BDU 406 and the electric motor 404. The battery 402 can be a high voltage battery with a voltage of at 200V, at least 400V, less than or equal to 850V, or other values. The vehicle 400 includes the cold plate 250 and the charger 260. The BDU 406 (e.g., the electrical assembly 20) and the charger 260 can both be coupled with the same cold plate 250, in some configurations. The vehicle 400 and/or the electrical assembly 20 can include a controller 410 connected to some or all of the battery 402, the BDU 406, the electrical assembly 20, the charger 260, and/or the motor 404, such as to control, at least in part, operation thereof.

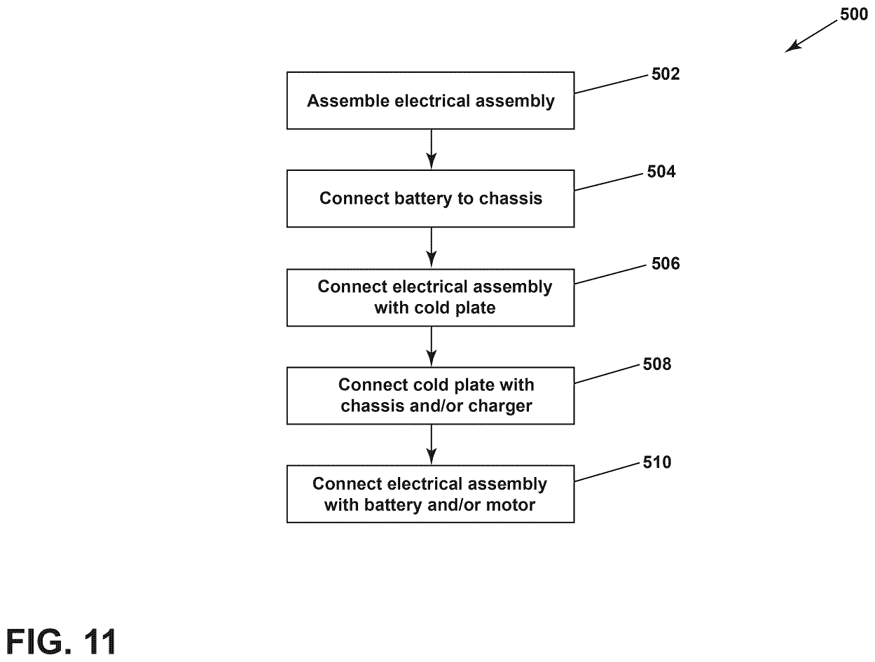

Referring to FIG. 11, a method 500 of assembly a vehicle 400 includes assembling the electrical assembly 20 (block 502), such as via method 300, connecting the battery 402 with the chassis (block 504), connecting (e.g., mechanically and thermally coupling) the electrical assembly 20 with a cold plate 250 (block 506), connecting the cold plate 250 with the chassis 408 and/or the battery charger 260 (block 508), and/or electrically connecting the electrical assembly 20 with the battery 402 and/or the electrical motor 404 (block 510).

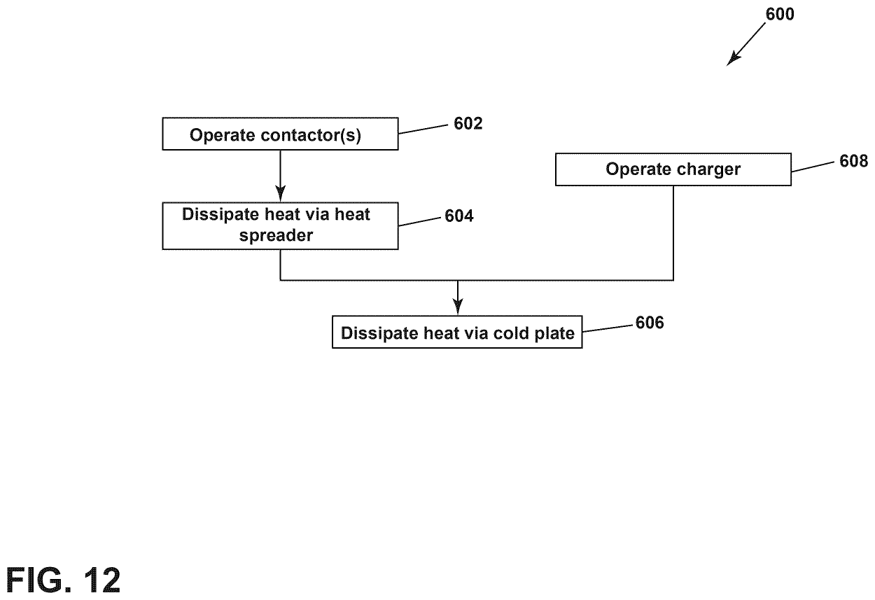

Referring to FIG. 12, a method 600 of operating the vehicle 400 includes operating at least one of the contactors 22, 24 to electrically connect the battery 402 with the electric motor 404 (block 602), such as to drive the vehicle 400. Electrical current flowing between the battery 402 and the electric motor 404 generates heat, and the method 500 includes dissipating at least a portion of the heat via the heat spreader 28 (block 604). Dissipating heat via the heat spreader 28 can include transferring heat from one or both contactors 22, 24 to the heat spreader 28 and/or transferring heat from the set of bus bars 26 to the heat spreader 28. The heat spreader 28 can dissipate heat via the fins 154. In configurations in which the electrical assembly 20 includes or is connected to a cold plate 250, the method 500 can include the cold plate 250 dissipating heat from the heat spreader 28 (block 606), such as heat not dissipated via the fins 154. Optionally, the method 600 includes operating the charger 260 (block 608), such as to charge the battery 402, and dissipating heat from the charger 260 via the cold plate 250 (block 606). The method 600 may be carried out, at least in part, via the controller 410.

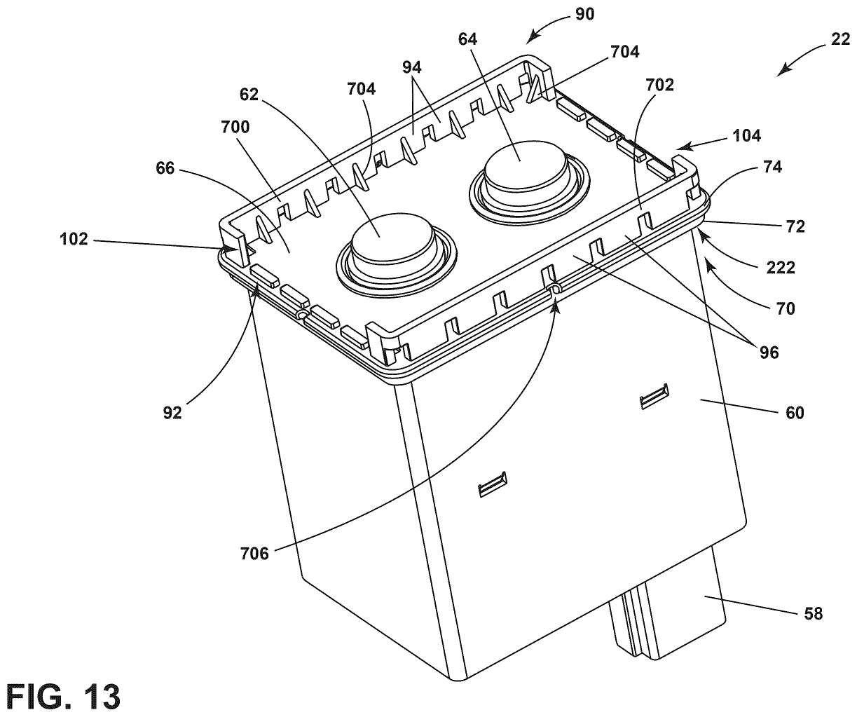

Referring to FIG. 13, the housing 60 of the first contactor 22 is shown with an elongated portion 700 that connects at least two of the first tabs 90, which can include all of the first group of first tabs 94. The housing 60 is also shown with a second elongated portion 702 that connects at least two of the first tabs 90, which can include all of the second group of first tabs 96. The elongated portions 700, 702 are disposed at distal ends of the first tabs 90 and extend across the gaps 82. The gaps 82 allow for the thermoset material 278 to flow between the tabs 80, such as to cover the first side 66, portions of the set of bus bars 26, and/or the terminals 62, 64. The elongated portions 700, 702 can allow the first and second groups of first tabs 94, 96 to function as walls instead of individual tabs. Optionally, the elongated portions 700, 702 extend at least partially along three sides of the contactor 22 (e.g., have a C-shaped configuration) and are curved at the corners of the contactor 22. During formation of the heat spreader 28, the contactor 22 may be placed in the mold 270 (FIG. 8) such that elongated portions are in contact with the mold 270 and support the contactor 22. The mold 270 may apply a clamping force to the housing 60, such as at the inner surface 222 of the first section 72 of the flange 70, and the elongated portions 700, 702 with the first tabs 90 withstand the clamping force. The housing 60 is shown with gussets 704 extending between the first side 66 of the housing 60 and the first tabs 90, such as to strengthen the first tabs 90. The housing 60 is also shown with locating recesses 706 (e.g., notches) that can engage locating pins of the mold 270 (FIG. 8) during formation of the heat spreader 28. The locating recesses 706 can be formed in the second section 74 of the flange 70.

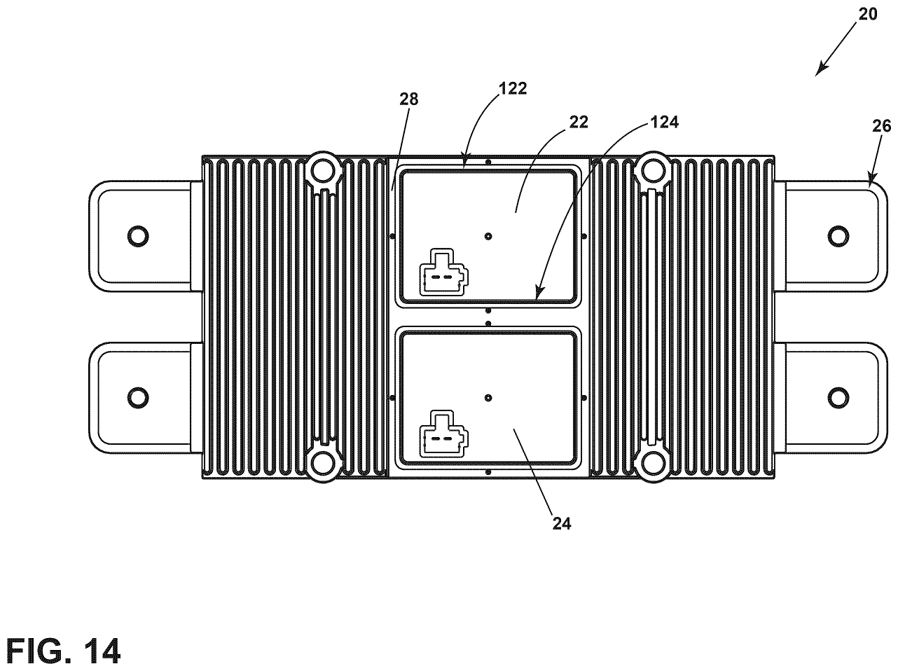

Referring to FIG. 14, the set of bus bars 26 can include a variety of configurations. While shown with L-shaped configurations in other drawings, the set of bus bars 26 can include linear configurations and may be parallel with the long sides 122, 128 of the contactors 22, 24.

While illustrated with two contactors 22, 24, the electrical assembly 20 can include other numbers of contactors, such as a single contactor or more than two contactors.

Embodiments of the electrical assembly 20 disclosed herein can have various advantages, including utilizing fewer fasteners, comprising more consistent spacing between components, improved electrical characteristics, being adaptable to various configurations and environments. Utilizing fewer fasteners can be provided by welding the bus bars with the contactor terminals and forming the heat spreader directly onto and around the bus bars and contactors (e.g., onto the flange). Utilizing fewer fasteners can also provide more consistent spacing between components, such as by reducing differences in torque applied from one fastener to the next and from one electrical assembly to the next. The more consistent spacing and/or use of a cured thermoset (e.g., a rigid material) can also provide more consistent electrical isolation between various components (e.g., bus bars, contactors), such as compared to utilizing thermal paste. Embodiments of the electrical assembly 20 can be scaled and the shape of the heat spreader can be modified to accommodate different applications and bus bar shapes, such as without or with limited further design validation.

The instant disclosure includes the following non-limiting embodiments:

An electrical assembly, comprising: an electrical contactor including a first terminal; a bus bar connected to the first terminal; and a heat spreader molded onto the electrical contactor and the bus bar.

The electrical assembly of any preceding embodiment, wherein the heat spreader comprises a thermoset material that is electrically insulating and thermally conductive.

The electrical assembly of any preceding embodiment, wherein the heat spreader comprises a ceramic material that is electrically insulating and thermally conductive.

The electrical assembly of any preceding embodiment, wherein the bus bar is mechanically and electrically connected with the first terminal.

The electrical assembly of any preceding embodiment, wherein the bus bar is welded with the first terminal.

The electrical assembly of any preceding embodiment, wherein the electrical contactor includes a housing comprising a plurality of tabs separated by a plurality of gaps.

The electrical assembly of any preceding embodiment, wherein the plurality of tabs are embedded in the heat spreader.

The electrical assembly of any preceding embodiment, wherein the bus bar is disposed partially in a recess defined at least partially by the plurality of tabs.

The electrical assembly of any preceding embodiment, wherein the housing includes a flange comprising a first section and a second section that extends beyond the first section.

The electrical assembly of any preceding embodiment, wherein the heat spreader is molded onto the second section to mechanically couple the electrical contactor with the heat spreader.

The electrical assembly of any preceding embodiment, wherein the heat spreader is molded onto the second section such that the second section is at least partially disposed between portions of the heat spreader and such that at least some of the first section is not covered by the heat spreader.

The electrical assembly of any preceding embodiment, wherein the heat spreader includes a plurality of cooling fins.

The electrical assembly of any preceding embodiment, comprising a second bus bar; wherein the electrical contactor includes a second terminal; the bus bar is welded to the first terminal; the second bus bar is welded to the second terminal; and the heat spreader is molded onto the second bus bar.

The electrical assembly of any preceding embodiment, comprising a second electrical contactor including a second contactor first terminal and a second contactor second terminal, a third bus bar welded to the second contactor first terminal, and fourth bus bar welded to the second contactor second terminal; wherein the heat spreader is molded onto the second electrical contactor, the third bus bar, and the fourth bus bar.

The electrical assembly of any preceding embodiment, comprising a second bus bar including a second bus bar first end; wherein the electrical contactor includes a housing and a second terminal; the first terminal and the second terminal extend from a first side of the housing; the second bus bar first end is welded to the second terminal; the bus bar includes a first bus bar first end welded to the first terminal; and a portion of the heat spreader is disposed between the first bus bar first end and the second bus bar first end.

The electrical assembly of any preceding embodiment, wherein the contactor housing includes a second side opposite the first side and includes an electrical connector disposed at the second side.

The electrical assembly of any preceding embodiment, wherein the electrical contactor is disposed at a first side of the heat spreader; and a second side of the heat spreader is planar.

The electrical assembly of any preceding embodiment, comprising a cold plate coupled with the second side of the heat spreader.

A vehicle, comprising: a battery; an electric motor; and a battery disconnect unit (BDU) selectively electrically connecting the battery with the electric motor, the BDU including the electrical assembly of any preceding embodiment.

A method of assembling the electrical assembly of any preceding embodiment, the method comprising: connecting the bus bar to the first terminal; and molding the heat spreader onto the electrical contactor and the bus bar.

The method of any preceding embodiment, wherein the molding includes transfer molding.

The method of any preceding embodiment, wherein the molding includes disposing the bus bar at least partially in a first mold and disposing the contactor at least partially in a second mold.

The method of any preceding embodiment, wherein the molding includes providing a thermoset material into the first mold and the second mold; and the thermoset material is electrically insulating and thermally conductive.

The method of any preceding embodiment, wherein the molding includes forming a plurality of cooling fins.

The method of any preceding embodiment, wherein the molding includes forming a plurality of mounting apertures.

The method of any preceding embodiment, wherein the molding includes leaving a portion of the bus bar uncovered for connection with an external component.

The method of any preceding embodiment, wherein the electrical contactor includes a housing comprising a plurality of tabs separated by a plurality of gaps; and

the molding includes the thermoset material flowing through at least one gap of the plurality of gaps.

A method of assembling a vehicle comprising the electrical assembly of any preceding embodiment, the method comprising: assembling the electrical assembly; connecting a battery of the vehicle with a chassis of the vehicle; connecting the electrical assembly with a cold plate; connecting the cold plate with the chassis and/or a battery charger; and electrically connecting the electrical assembly with the battery.

A vehicle including the electrical assembly of any preceding embodiment.

An electronic controller configured to implement the method of any preceding embodiment.

A non-transitory computer-readable storage medium having a computer program encoded thereon for implementing the method of any preceding embodiment.

In examples, a controller (e.g., the electronic controller 410) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes.” “including.” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

References to a vehicle can include one or more of a variety of vehicles, including, without limitation, a passenger car (e.g., a sedan, a pickup truck, a sport utility vehicle, a crossover, etc.), a truck, a bus, a plane, or a boat, among others.

All matter contained in the above description or shown in the accompanying drawings shall be interpreted as illustrative only and not limiting. Changes in detail or structure may be made without departing from the present disclosure.

A controller, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. An electrical assembly, comprising:
an electrical contactor including a first terminal;
a bus bar connected to the first terminal; and
a heat spreader molded onto the electrical contactor and the bus bar.

2. The electrical assembly of claim 1, wherein the heat spreader comprises a thermoset material that is electrically insulating and thermally conductive.

3. The electrical assembly of claim 1, wherein the bus bar is welded with the first terminal.

4. The electrical assembly of claim 1, wherein the electrical contactor includes a housing comprising a plurality of tabs separated by a plurality of gaps.

5. The electrical assembly of claim 4, wherein the plurality of tabs are embedded in the heat spreader.

6. The electrical assembly of claim 4, wherein the bus bar is disposed partially in a recess defined at least partially by the plurality of tabs.

7. The electrical assembly of claim 4, wherein the housing includes a flange comprising a first section and a second section that extends beyond the first section.

8. The electrical assembly of claim 7, wherein the heat spreader is molded onto the second section to mechanically couple the electrical contactor with the heat spreader.

9. The electrical assembly of claim 8, wherein the heat spreader is molded onto the second section such that the second section is at least partially disposed between portions of the heat spreader and such that at least some of the first section is not covered by the heat spreader.

10. The electrical assembly of claim 1, wherein the heat spreader includes a plurality of cooling fins.

11. The electrical assembly of claim 1, comprising a second bus bar;
wherein the electrical contactor includes a second terminal;
the bus bar is welded to the first terminal;
the second bus bar is welded to the second terminal; and
the heat spreader is molded onto the second bus bar.

12. The electrical assembly of claim 11, comprising a second electrical contactor including a second contactor first terminal and a second contactor second terminal, a third bus bar welded to the second contactor first terminal, and fourth bus bar welded to the second contactor second terminal;
wherein the heat spreader is molded onto the second electrical contactor, the third bus bar, and the fourth bus bar.

13. The electrical assembly of claim 1, comprising a second bus bar including a second bus bar first end;
wherein the electrical contactor includes a housing and a second terminal;
the first terminal and the second terminal extend from a first side of the housing;
the second bus bar first end is welded to the second terminal;
the bus bar includes a first bus bar first end welded to the first terminal; and
a portion of the heat spreader is disposed between the first bus bar first end and the second bus bar first end.

14. The electrical assembly of claim 13, wherein the housing includes a second side opposite the first side and includes an electrical connector disposed at the second side.

15. The electrical assembly of claim 1, wherein the electrical contactor is disposed at a first side of the heat spreader; and
a second side of the heat spreader is planar.

16. The electrical assembly of claim 15, comprising a cold plate coupled with the second side of the heat spreader.

17. A vehicle, comprising:
a battery;
an electric motor; and
a battery disconnect unit (BDU) selectively electrically connecting the battery with the electric motor, the BDU including the electrical assembly of claim 1.

18. A method of assembling the electrical assembly of claim 1, the method comprising:
connecting the bus bar to the first terminal; and
molding the heat spreader onto the electrical contactor and the bus bar.

19. The method of claim 18, wherein the molding includes transfer molding.

20. The method of claim 19, wherein the molding includes disposing the bus bar at least partially in a first mold and disposing the contactor at least partially in a second mold;
the molding includes providing a thermoset material into the first mold and the second mold;
the thermoset material is electrically insulating and thermally conductive;
the molding includes forming a plurality of cooling fins;
the molding includes forming a plurality of mounting apertures;
the molding includes leaving a portion of the bus bar uncovered for connection with an external component;
the electrical contactor includes a housing comprising a plurality of tabs separated by a plurality of gaps; and
the molding includes the thermoset material flowing through at least one gap of the plurality of gaps.
